(19) United States
(12) Patent Application Publication
(10) Pub. No.: US 2012/0077372 A1
(43) Pub. Date: Mar. 29, 2012

(54) CABLE JUMPER HAND REEL

(75) Inventor: NOAH P. MONTENA, Syracuse, NY (US)

(73) Assignee: JOHN MEZZALINGUA ASSOCIATES, INC., East Syracuse, NY (US)

(21) Appl. No.: 12/889,856

(22) Filed: Sep. 24, 2010

(51) Int. Cl. H01R 13/72; B65H 75/44; B65H 75/38

(52) U.S. Cl. 439/501; 242/405; 242/402

(57) ABSTRACT

A cable jumper hand reel. In one example embodiment, a hand reel includes a stationary concave track and a rotatable guide at least partially retained within the track and configured to be rotated around the guide. The guide includes a plurality of concave brackets that are coupled to each other and spaced apart from each other around the track. The brackets are configured to retain a coiled line.

### BACKGROUND

A cable jumper is a relatively short length of cable that is terminated on either end by a cable connector. For example, a jumper may be 25 feet, 50 feet, 100 feet, or 500 feet in length. Jumpers can be used in a variety of settings for a variety of applications. For example, jumpers used with portable musical equipment, such as electric guitars and amplifiers, may require a jumper to be repeatedly uncoiled and recoiled before and after use.

Cable technicians typically coil jumpers by hand, often by looping the jumper around the palm and elbow of one arm while pulling and winding the cable with the other arm and hand. Unfortunately, however, the conventional hand coiling of jumpers can be cumbersome and time consuming. The jumper tends to become twisted during coiling, often against the bias of the cable, which makes coiling difficult and can damage the jumper. Further, unless ties or straps are wrapped around the jumper after coiling, the coiled jumper can become inadvertently uncoiled or tangled with itself or with other jumpers.

### SUMMARY OF SOME EXAMPLE EMBODIMENTS

In general, example embodiments of the present invention relate to a cable jumper hand reel. The example hand reel disclosed herein enables a cable technician to quickly and easily coil and uncoil a cable jumper. The coiled jumper can also be stored on the example hand reel while adding only relatively little weight and bulk to the coiled jumper. Coiling a jumper on the example hand reel disclosed herein reduces or eliminates twisting of the jumper, thus making coiling of the jumper less difficult and less likely to damage the jumper. Further, storing a jumper on the example hand reel disclosed herein eliminates the need for additional ties or straps to avoid the uncoiling or tangling of the jumper.

In one example embodiment, a hand reel includes a stationary concave track and a rotatable guide at least partially retained within the track and configured to be rotated around the track. The guide includes a plurality of concave brackets that are coupled to each other and spaced apart from each other around the guide. The brackets are configured to retain a coiled line.

In another example embodiment, a hand reel includes an annular stationary concave track and a rotatable guide at least partially retained within the track and configured to be rotated around the track. The guide includes first and second annular rails and a plurality of concave brackets connected to and spaced apart around the first and second rails. The brackets are configured to retain a coiled line.

In yet another example embodiment, a cable package includes a cable jumper and a hand reel. The cable jumper includes a length of cable terminated on either end by a cable connector. The hand reel includes an annular stationary concave track and a rotatable guide at least partially retained within the track and configured to be rotated around the track. The guide includes first and second annular rails and a plurality of concave brackets connected to and spaced apart around the first and second rails. A coiled portion of the cable jumper is retained within the brackets.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter. Moreover, it is to be understood that both the foregoing general description and the following detailed description of the present invention are exemplary and explanatory and are intended to provide further explanation of the invention as claimed.

### BRIEF DESCRIPTION OF THE DRAWINGS

Aspects of example embodiments of the present invention will become apparent from the following detailed description of example embodiments given in conjunction with the accompanying drawings, in which:

FIG. 1A is a perspective view of an example hand reel;

FIG. 1B is a perspective exploded view of the example hand reel of FIG. 1A;

FIG. 1C is a perspective view of an example cable jumper coiled around the example hand reel of FIG. 1A;

FIG. 1D is a cross-sectional view of a portion of the example jumper of FIG. 1C coiled around a portion of the example hand reel of FIG. 1A;

FIGS. 2A and 2B disclose the example jumper of FIG. 1C being coiled around the example hand reel of FIG. 1A; and

FIG. 3 is a perspective view of an alternative cable jumper coiled around an alternative embodiment of the example hand reel of FIG. 1A.

### DETAILED DESCRIPTION OF SOME EXAMPLE EMBODIMENTS

Example embodiments of the present invention relate to a cable jumper hand reel. In the following detailed description of some example embodiments, reference will now be made in detail to example embodiments which are illustrated in the accompanying drawings. Wherever possible, the same reference numbers will be used throughout the drawings to refer to the same or like parts. These embodiments are described in sufficient detail to enable those skilled in the art to practice the invention. Other embodiments may be utilized and structural changes may be made without departing from the scope of the present invention. Moreover, it is to be understood that the various embodiments of the invention, although different, are not necessarily mutually exclusive. For example, a particular feature, structure, or characteristic described in one embodiment may be included within other embodiments. The following detailed description is, therefore, not to be taken in a limiting sense, and the scope of the present invention is defined only by the appended claims, along with the full scope of equivalents to which such claims are entitled.

### I. Example Cable Jumper Hand Reel

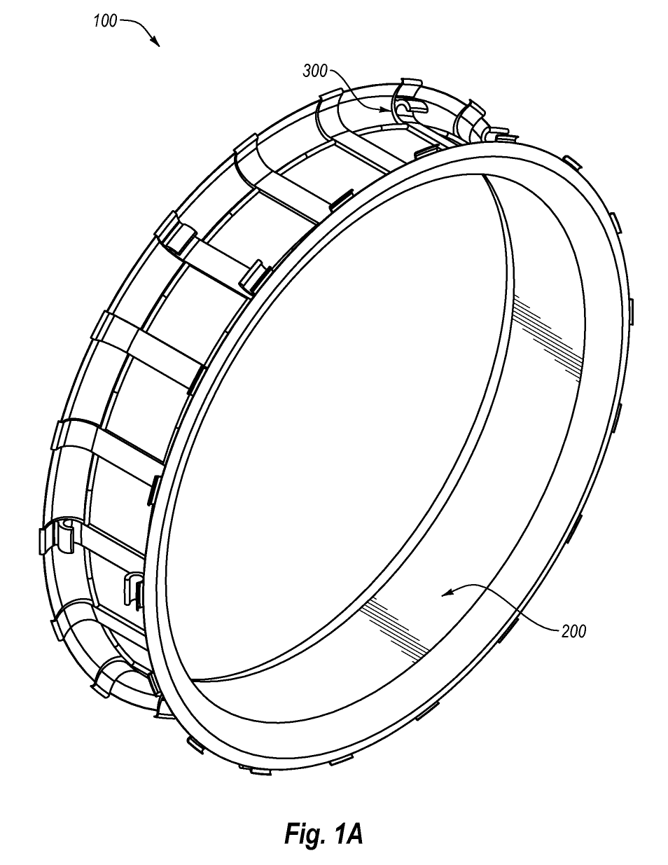

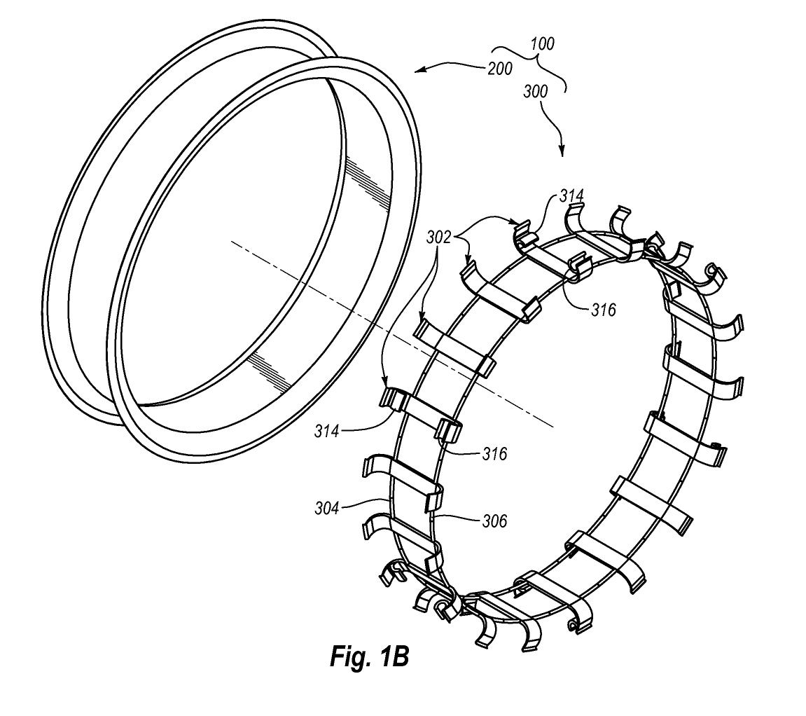

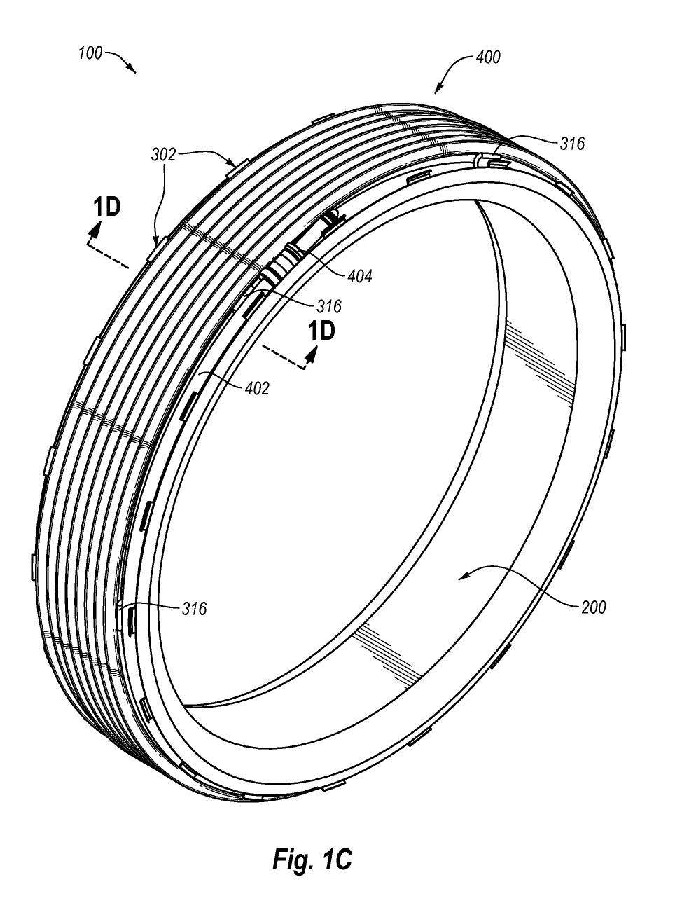

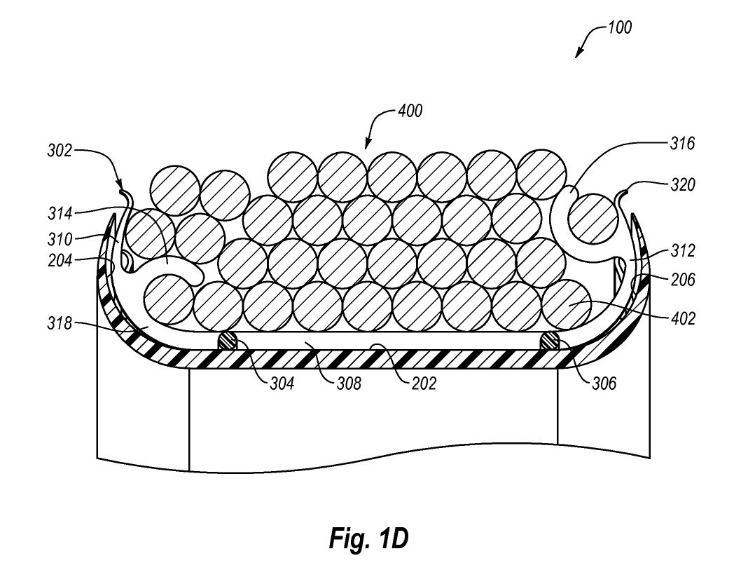

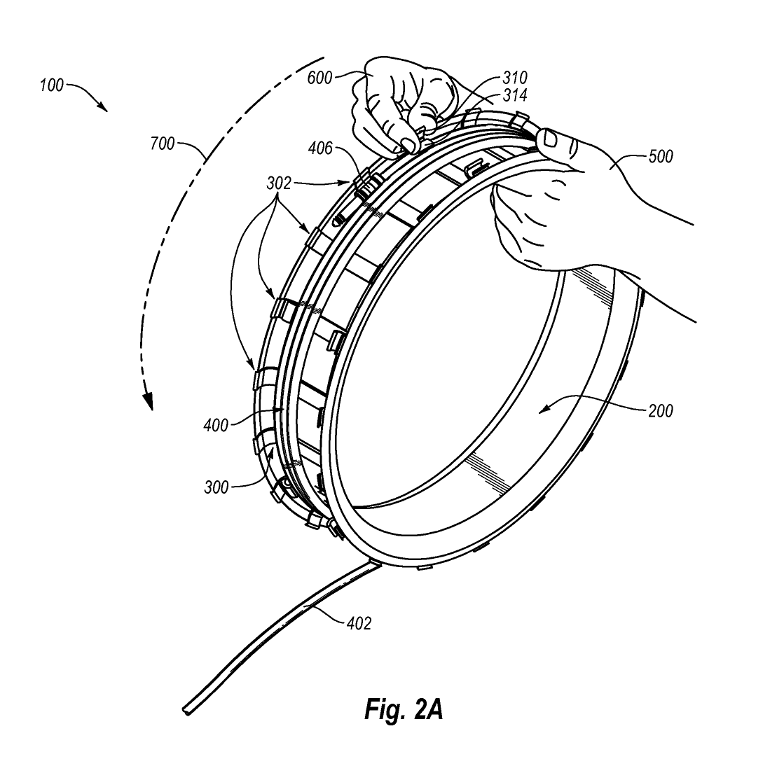

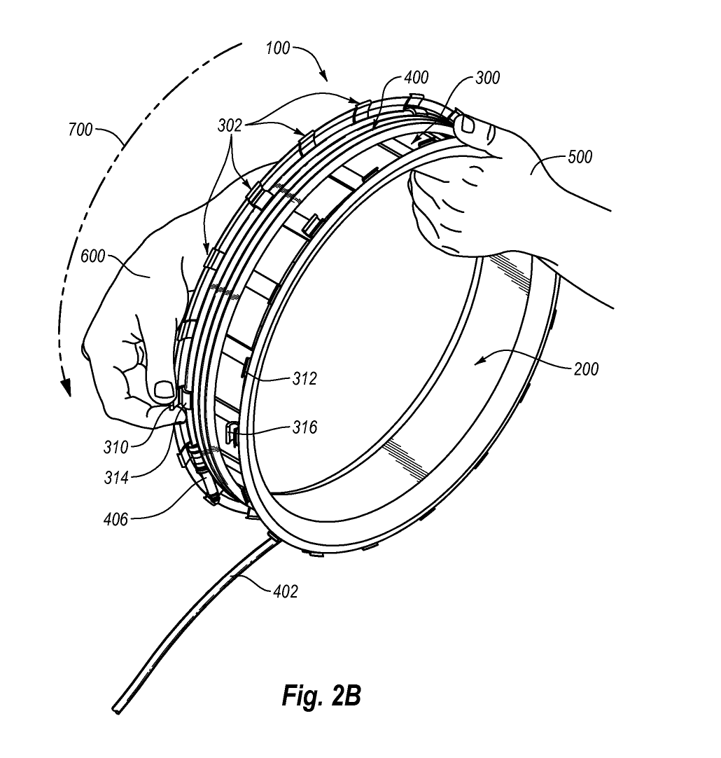

With reference now to FIGS. 1A and 1B, an example cable jumper hand reel 100 is disclosed. The example hand reel 100 includes a track 200 and a guide 300. The guide 300 is at least partially retained within the track 200 and is configured to be rotated around the track 200 while the track 200 is configured to remain stationary. The guide 300 includes a plurality of concave brackets 302 coupled to each other and spaced apart from each other around the guide 300. The brackets 302 are configured to retain a coiled cable jumper 400 (see FIGS. 1C-2B).

As disclosed in FIG. 1B, the brackets 302 are coupled to each other via first and second annular rails 304 and 306. The rails 304 and 306 and the brackets 302 of the guide 300 are formed from a material that is sturdy and able to slide easily along the track 200. For example, both the track 200 as well as the guide 300 may be formed from polypropylene, semi-rigid polyvinyl chloride (semi-rigid PVC), polyethylene, or some combination thereof. Each of the track 200 and the guide 300 may be integrally molded as a single piece loop. Once integrally molded, the guide 300 can be temporarily stretched to be slipped onto and seated within the track 200 and/or at least a portion of the track 200 can be temporarily deformed in order to allow the guide to be slipped onto and seated within the track 200. Alternatively, the guide 300 may be molded as a linear chain and later joined into a loop around the track 200 during assembly of the example hand reel 100.

It is understood, that the brackets 302 may be coupled to each another via another structure or other structures that is/are similarly formed from a material configured to slide easily along the track 200. For example, the brackets 302 may instead be coupled to each another via a band, a strap, a ribbon, a single rail, or some combination thereof.

As disclosed in FIGS. 1B and 1C, each of the brackets 302 is configured to reduce or prevent the coiled jumper 400 from touching or rubbing against the track 200. As disclosed in FIG. 1D, each bracket 302 may include a base 308 and first and second flanges 310 and 312 extending from the base 308. The base 308 of each bracket 302 reduces or prevents the coiled jumper 400 from touching or rubbing against a bottom surface 202 of the track 200. Similarly, the first and second flanges 310 and 312 reduce or prevent the coiled jumper 400 from touching or rubbing against side surfaces 204 and 206 of the track 200, respectively. The first flange 310 and the second flange 312 of each bracket may be about equal in height in order to evenly retain the coiled jumper 400.

As disclosed in FIG. 1B, one or more of the brackets 302 may also include a clip 314 and/or a clip 316. As disclosed in FIG. 1D, each clip 314 is positioned proximate a joint 318 between the base 308 and the first flange 310 of the bracket 302, and each clip 316 is positioned proximate a terminal end 320 of the second flange 312 of the bracket 302. The clip 314 is configured to releasably clamp an inner coil of the jumper 400, prior to the coiling of the jumper 400. Similarly, the clip 316 is configured to releasably clamp an outer coil of the jumper 400, subsequent to the coiling of the jumper 400.

The clips 314 and 316 may be interspersed around the brackets 302 of the guide 300. For example, as disclosed in FIG. 1B, every third bracket 302 may include a clip 314 and a clip 316. As disclosed in FIGS. 1A-1C, interspersing multiple clips 314 and 316 around the guide 300 enables the jumper 400 to be clipped to the guide 300 at any of a variety of positions.

It is understood, however, that the guide 300 may instead include fewer clips 314 and/or 316 or more clips 314 and/or 316 than is disclosed in the drawings. For example, the guide 300 may include only a single clip 314 and a single clip 316, thus requiring first and second ends of the jumper 400 to be clipped to the guide 300 at the position of the single clip 314 and the single clip 316, respectively. Conversely, the guide 300 may include a clip 314 and/or a clip 316 on every bracket 302, thus maximizing the positions along the guide 300 to which the jumper 400 can be clipped. Also, the clips 314 and the clips 316 may be included on separate brackets 302.

Further, although the clip 314 is disclosed in FIG. 1D as configured to receive the cable 402 by sliding the cable 402 horizontally, it is understood that any one of the clips 314 may instead be configured to receive the cable 402 vertically, similar to the configuration of the clip 316. Likewise, although the clip 316 is disclosed in FIG. 1D as configured to receive the cable 402 by sliding the cable 402 vertically, it is understood that any one of the clips 316 may instead be configured to receive the cable 402 horizontally, similar to the configuration of the clip 314.

As disclosed in FIGS. 1B and 1D, the overall volume of the guide 300 is less than the overall volume of the track 200. As disclosed in FIGS. 1B-1D, the overall volume of the example hand reel 100 is significantly less than the overall volume of the coiled jumper 400. The relatively low volume of the example hand reel 100 results in the overall bulk and weight of the hand reel 100 amounting to only a relatively small fraction of the bulk and weight of the jumper 400.

### II. Operation of the Example Hand Reel

With reference now to FIGS. 2A and 2B, the operation of the example hand reel 100 is disclosed. In particular, FIGS. 2A and 2B disclose the example hand reel 100 being used to coil the example jumper 400. As disclosed in FIGS. 2A and 1C, the example jumper 400 includes a length of one-fourth inch diameter cable 402 terminated on a first end by a first cable connector 406 and terminated on a second end by a second cable connector 404. Although the cable connectors 402 and 404 are disclosed in the drawings as standard phone plugs, it is understood that the example hand reel 100 can accommodate jumpers having other types of cable connectors.

As disclosed in FIG. 2A, prior to coiling, a first end of the example jumper 400 can be clipped into one of the clips 314. As noted above, the clips 314 are interspersed around the brackets 302 of the guide 300, with one clip 314 being included on every third bracket 302, which enables the first end of the jumper 400 to be clipped to the track 300 at a variety of positions. Once the jumper 400 has been clipped to one of the clips 314, a cable technician can hold the track 200 in a stationary position with his left hand 500 and can rotate the guide 300 with his right hand 600. In order to rotate the guide 300, the technician can, for example, grasp one of the flanges 310 between the thumb and forefinger of his right hand 600, as shown in FIG. 2A, then push on the grasped flange 310 in the direction of the arrow 700. Alternatively, the cable technician can rotate the guide 300 in the direction of the arrow 700 by pushing against or pulling on one of the clips 314, one of the flanges 312, or the coiled portion of the jumper 400, or some combination thereof.

As disclosed in the progression from FIG. 2A to FIG. 2B, the rotation of the guide 300 around the track 200 in the direction of the arrow 700 results in the coiling of the jumper 400 around the example hand reel 100. It is understood that the guide 300 can be repeatedly rotated as disclosed in FIGS. 2A and 2B until the jumper 400 is completely coiled around the example hand reel 100.

Once the jumper 400 is completely coiled around the example hand reel 100, a second end of the jumper 400 can be clipped into one of the clips 316. As noted above, the clips 316 are interspersed around the brackets 302 of the guide 300, with one clip 316 being included on every third bracket 302, which enables the second end of the jumper 400 to be clipped to the guide 300 at a variety of positions. Once the second end of the jumper 400 is clipped to one of the clips 316, the coiled jumper 400 is securely attached to the example guide 300.

It is understood that the coiled jumper 400 can also be easily uncoiled from the example hand reel 400. For example, after unclipping the second end of the jumper 400 from the clip 316 or clips 316, the cable technician can hold the track 200 in a stationary position with his left hand 500 and can rotate the guide 300 with his right hand 600 in the opposite direction of the arrow 700, or allow the guide 300 to automatically rotate by pulling on the second end of the jumper 400. For example, the cable connector 404 (see FIG. 1C) of the second end of the jumper 400 can be attached to a stationary device, and the cable technician can cause the guide 300 to rotate, thus uncoiling the jumper 400, by simply walking away from the stationary device while holding the track 200 stationary with either his left hand 500 or right hand 600. Once uncoiled, the jumper 400 can be completely detached from the example hand reel 100 by unclipping the jumper 400 from the clip 314 or clips 314.

Therefore, the example hand reel 100 enables a cable technician to quickly and easily coil and uncoil the jumper 400. The coiled jumper 400 can also be stored on the example hand reel 100 while adding only relatively little weight and bulk to the coiled jumper 400. Coiling the jumper 400 on the example hand reel 100 reduces or eliminates twisting of the jumper 400, thus making coiling of the jumper 400 less difficult and less likely to damage the jumper 400. Further, storing the jumper 400 on the example hand reel 100 eliminates the need for additional ties or straps to avoid the uncoiling or tangling of the jumper 400.

Although not disclosed in the drawings, it is understood that the example hand reel 100 may further include a visible indicator (not shown) that designates the diameter and/or length of cable for which the hand reel 100 is configured to coil. For example, the hand reel 100 can include a color, visible texture, visible characters, or other visibly perceptible characteristic(s) on a surface of the hand reel 100 to visibly specify the particular size and length of jumper that the hand reel 100 is configured to coil. As a cable technician may need to coil jumpers of different sizes and lengths, this visible indicator can enable the technician to quickly distinguish between differently configured hand reels 100. For example, one hand reel 100 may be configured to coil one-hundred feet of one-fourth inch diameter cable, while another hand reel 100 may be configured to coil five-hundred feet of one-half inch diameter cable.

It is further understood that various hand reels may be configured to accommodate various diameters and lengths of cable. For example, while the clips 314 and clips 316 of the example hand reel 100 are configured to accommodate one-fourth inch diameter cable, the clips 314 and 316 may be replaced with clips configured to accommodate other cable diameters.

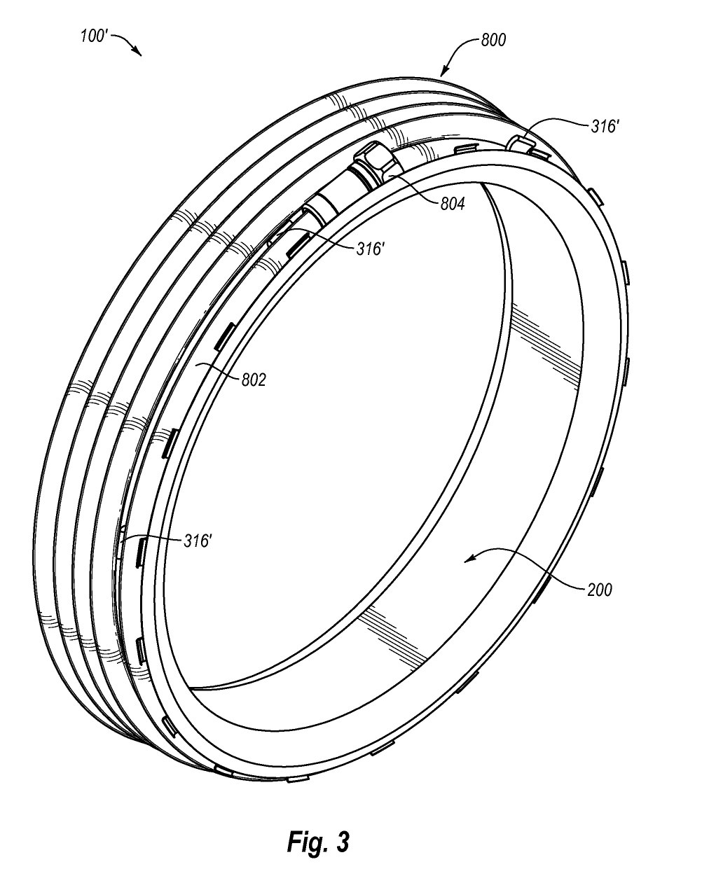

For example, FIG. 3 discloses an alternative embodiment 100′ of the hand reel 100 where the clips 314 and 316 are replaced with larger clips (only portions of the larger clips 316′ are shown in FIG. 3). FIG. 3 also discloses an alternative cable jumper 800 that includes a length of one-half inch diameter coaxial cable 802 terminated on a first end by a first coaxial cable connector (not shown) and terminated on a second end by a second coaxial cable connector 804. While the clips 316 of the example hand reel 100 of FIG. 1C are configured to accommodate the smaller one-fourth inch diameter cable 402, the clip 316′ of the alternative hand reel 100′ is configured to accommodate the larger one-half inch diameter cable 802. It is understood that the maximum length of the jumper 800 that can be accommodated on the alternative hand reel 100′ is less than the maximum length of the jumper 400 that can be accommodated on the example hand reel 100 due to the increased diameter of the cable 802 of the jumper 800.

It is further understood that a single hand reel may be configured to accommodate various diameters and lengths of cable. For example, while some of the clips 314 and clips 316 of the example hand reel 100 of FIG. 1B may be configured to accommodate one-fourth inch diameter cable, other of the clips 314 and 316 may be configured to accommodate one-half inch diameter cable. With the clips 314 and 316 thus configured, a single example hand reel 100 may be used to coil either about one-hundred feet of one-fourth inch diameter cable or about twenty-five feet of one-half inch diameter cable. The hand reel 100 in this example may include a visible indicator that designates both one-hundred feet of one-fourth inch diameter cable, as well as about twenty-five feet of one-half inch diameter cable, such as—¼″×100′ OR ½″×25′—.

It is also understood that the example hand reels 100 and 100′ disclosed herein are not limited for use in coiling the cable jumpers 400 and 800 disclosed herein, but can also be used to coil various other lines of various diameters and lengths including, but not limited to, electrical extension cords, appliance cords, microphone cords, telephone lines, Ethernet cables, hoses, and ropes. The clips 314, 316, and 316′ can also be modified or replaced with various other clips to accommodate lines of various diameters.

The example embodiments disclosed herein may be embodied in other specific forms. The example embodiments disclosed herein are to be considered in all respects only as illustrative and not restrictive.

What is claimed is:

1. A hand reel comprising:
a stationary concave track; and
a rotatable guide at least partially retained within the track and configured to be rotated around the track, the guide comprising a plurality of concave brackets coupled to each other and spaced apart from each other around the guide, the brackets configured to retain a coiled line.

2. The hand reel as recited in claim 1, wherein one or more of the brackets includes a clip configured to releasably clamp an inner coil of the coiled line.

3. The hand reel as recited in claim 2, wherein the clip is positioned proximate a joint between a base and a flange of the bracket.

4. The hand reel as recited in claim 1, wherein one or more of the brackets includes a clip configured to releasably clamp an outer coil of the coiled line.

5. The hand reel as recited in claim 4, wherein the clip is positioned proximate a terminal end of a flange of the bracket.

6. The hand reel as recited in claim 1, wherein the track and the guide are each formed from polyethylene.

7. The hand reel as recited in claim 1, wherein the overall volume of the guide is less than the overall volume of the track.

8. A hand reel comprising:
an annular stationary concave track; and
a rotatable guide at least partially retained within the track and configured to be rotated around the track, the guide comprising:
first and second annular rails; and
a plurality of concave brackets connected to and spaced apart around the first and second rails, the brackets configured to retain a coiled line.

9. The hand reel as recited in claim 8, wherein one or more of the brackets includes a clip configured to releasably clamp an inner coil of the coiled line, the clip being positioned proximate a joint between a base and a flange of the bracket.

10. The hand reel as recited in claim 8, wherein one or more of the brackets includes a clip configured to releasably clamp an outer coil of the coiled line, the clip being positioned proximate a terminal end of a flange of the bracket.

11. The hand reel as recited in claim 8, wherein the track and the guide are each formed from polyethylene.

12. The hand reel as recited in claim 8, wherein each bracket includes a base and first and second flanges extending from the base.

13. The hand reel as recited in claim 12, wherein each first flange is about equal in height to each second flange.

14. A cable package comprising:
a cable jumper comprising a length of cable terminated on either end by a cable connector; and
a hand reel comprising:
an annular stationary concave track; and
a rotatable guide at least partially retained within the track and configured to be rotated around the track, the guide comprising:
first and second annular rails; and
a plurality of concave brackets connected to and spaced apart around the first and second rails, a coiled portion of the cable jumper retained within the brackets.

15. The cable package as recited in claim 14, wherein one or more of the brackets includes a first clip releasably clamping a first end of the jumper, the first clip being positioned proximate a joint between a base and a flange of the bracket.

16. The cable package as recited in claim 15, wherein one or more of the brackets includes a second clip releasably clamping a second end of the jumper, the second clip being positioned proximate a terminal end of a flange of the bracket.

17. The cable package as recited in claim 16, wherein every third bracket includes a first clip and a second clip.

18. The cable package as recited in claim 14, wherein the track and the guide are each formed from polyethylene.

19. The cable package as recited in claim 14, wherein the overall volume of the guide is less than the overall volume of the track.

20. The cable package as recited in claim 14, wherein each bracket includes a base and first and second flanges extending from the base, and each first flange is about equal in height to each second flange.
